(19) United States
(12) Patent Application Publication
(10) Pub. No.: US 2010/0218893 A1
(43) Pub. Date: Sep. 2, 2010

(54) METHOD FOR THE PRODUCTION OF A METALLIC LINE PIPE WITH A FIRMLY ADHERING PLASTIC SHEATHING

(76) Inventors: Till Merkel, Neu-Ulm (DE); Rolf Werner, Nersingen (DE); Max Zanker, Illertissen (DE)

Correspondence Address: FLYNN THIEL BOUTELL & TANIS, P.C., 2026 RAMBLING ROAD, KALAMAZOO, MI, 49008-1631, US

(21) Appl. No.: 12/311,884

(22) PCT Filed: Dec. 1, 2007
(86) PCT No.: PCT/EP2007/010454

§ 371 Date: Apr. 16, 2009

(30) Foreign Application Priority Data
Dec. 8, 2006 (DE) 10 2006 057 884.8

(51) Int. Cl. B29C 65/02

(52) U.S. Cl. 156/322

(57) ABSTRACT

The invention relates to a method for the production of a metallic pipeline with firmly adherent plastics sheathing, where, by means of a plasma treatment or by means of a gas-burner flame, an activated surface is generated on a metal pipe, where the exposure time of the surface is less than 3 seconds, and a plastics sheathing is applied to the activated naked surface of the metal pipe and, at the juncture of application of the sheathing, the temperature of the surface of the metal pipe is below 80° C.

The invention relates to a method for the production of a metallic line pipe with a firmly adhering plastic sheathing according to the preamble of claim 1.

Line pipes insulated in this way are conventionally pipes made from metal and plastic components which are integrally connected to one another. By way of example, German laid-open specification 1 675 338 discloses a line pipe which is intended for liquids and gases and comprises a thin-walled copper pipe with a firmly adhering jacket made from thermoplastic polymer. The jacket can be produced by extrusion or by winding on plastic strips. The adhesion between plastic and metal is produced by forming a direct adhesive bond using a thermoplastic as the shell or by means of adhesive strips. In this connection, modified polyethylenes which consist of comonomers and comprise acrylate as a functional group are used, and this is conducive to good adhesion.

A further development of a thin-walled copper or steel pipe with a firmly adhering plastic jacket is also known from WO 2006/005297 A1. In order to improve the adhesion between metal and plastic, the metal surface is treated with reagents, which may be based on benzotriazole, as adhesion promoters. This document also proposes improving the adhesion properties by tin-plating the outer surface.

In addition, patent specification EP 0 794 376 B1, for example, discloses a composite pipe which comprises an internal copper film having an adhesion-promoter layer respectively along with an inner and outer polymer top layer. In this case, the inside and outside of the internal copper film are provided with an inorganic coating which is intended to prevent the formation and migration of ions. The coating is applied by immersion or by electrodeposition and preferably consists of nickel.

Other literature often discusses the adhesion between metal and plastic and measures for influencing this. It also describes improving the mechanical coupling between plastic and metal by roughening the surface or by deliberately introducing grooves. Adhesion to the metal surface is also improved by pre-treatment with non-oxidizing acids, in which poorly adhering oxide layers are removed. At the same time, a trough-shaped microroughness is produced. When oxidizing acids are used, it is additionally possible to apply still readily adhering oxide layers of a specific thickness. However, as a result of the physical structure of the metal lattice and the nature of the chemical bonds between various atoms, these oxide layers have strong polarities. As a result nonpolar polymers such as, for example, polyethylene adhere very poorly to metals. Adhesion promoters which comprise polar functional groups, for example ionomers, in a nonpolar polymer skeleton are used as an intermediate layer. However, there is a lack of complete clarity regarding the chemical processes of the mechanism for bonding the adhesion promoter to polar metal surfaces. It is assumed that this involves bonds whose bond energies are established between the covalent bonds of organic molecules and the ion bonds of salts. Irrespective of which of these two limiting cases more accurately describes the chemical realities, it cannot be disputed that the metal surfaces have to be at least partially oxidized in order to improve the adhesion. On the basis of this consideration metal surfaces are, for example, chromatized before they are provided with an organic coating in a coating process.

These statements therefore result in demands for a process which is intended to provide a metallic pipe surface with a firmly adhering polymer coating.

Therefore, the invention is based on the object of specifying a method for improving the adhesion of a plastic sheathing to a metallic line pipe.

The invention is represented by the features of claim 1. The further claims which refer back thereto relate to advantageous embodiments and developments of the invention.

The invention includes a method for the production of a metallic line pipe with a firmly adhering plastic sheathing, wherein
an activated metal pipe surface is produced by means of a plasma treatment or by means of a gas-burner flame, wherein the exposure time of the surface is less than 3 seconds,
a plastic sheathing is applied to the bare activated metal pipe surface, and
at the time when the sheathing is being applied, the temperature of the metal pipe surface is less than 80° C.

The invention is also based on the consideration that the method for the production of the line pipe with a plastic sheathing can be decoupled from the preceding method steps for preparing the pipe. The pipe is conventionally prepared by unwinding the wound pipe or conveying it out of a basket or a preceding manufacturing step, an annealing treatment and cooling, if appropriate with subsequent cold-forming. The method according to the invention activates the metal pipe surface immediately before the sheathing is applied and prepares it for good adhesion.

The exposure of the surface to a gas-burner flame with a process duration of less than 3 seconds is in the form of a temperature flash. Heating of the surface is avoided by means of short contact times, and the rise in temperature can be below 30° C. if the pipe is fed forward appropriately. Sufficiently activated surfaces can be obtained even with process durations of less than half a second.

A metallically bare and activated surface can be provided reliably and largely independently of the manufacturing speed by means of a plasma pre-treatment. This makes it possible to use a large spectrum of primary pipe material in baskets, in wound form or in straight lengths, if the starting materials already satisfy certain minimum requirements regarding the surface quality. The metallically bare and activated surface which is established can be quantified operationally by means of a measurement method and its sensitivity. As criteria for measuring the surface quality, it is possible to use the surface tension as a measure of the cleanness. Furthermore, no film of carbon which can be detected by means of the film test should be present on the surface. Soiling with particles can easily be tested in the process by means of a wiping test with a white fabric cloth. Pipe surfaces which satisfy the prescribed requirements are suitable for use as primary material for the sheathing with a firmly adhering plastic jacket and can be further-processed directly. The provision of a metallically bare activated surface is also an important prerequisite for decoupling the process sequence.

The oxidative treatment of the surfaces with the formation of an oxide layer is not required. However, activation of the surface by means of a gas burner, in particular with annular nozzles, has proved to be successful in use. The activation increases the reactivity of the surface, and therefore the reaction with the plastics material of the sheathing begins immediately after it has been applied and leads to the formation of a good adhesive bond between metal and plastic after just a short reaction time. Thermal activation is possible with a gas burner which is operated with an excess of oxygen or air. This can result in very high temperatures of above 500° C. which, however, act only briefly close to the surface. A similar activating effect is observed in accordance with a treatment with physical methods of the above-described plasma treatment. The beneficial effects which can be observed may be associated with microetching of the surface.

The particular advantage is that a plasma treatment or a treatment with a gas-burner flame activates the metal surface such that it is possible to apply a sheathing with particularly good adhesion in the immediately following process.

In a preferred configuration of the invention, methane, propane or butane with an excess of air may be used as burner gas when using a gas-burner flame. Advantageously, the burner gas may have a 20-30-fold excess of air when using a gas-burner flame.

In an advantageous configuration of the invention, at the time when the sheathing is being applied, the temperature of the metal pipe surface may be from room temperature up to at most 50° C. Particularly good adhesion results are obtained whenever the activated pipe enters the extruder with a defined and relatively low surface temperature.

In a preferred embodiment of the invention, the metal pipe surface may be provided with an adhesion promoter before the sheathing is applied. In order to apply the adhesion promoter and the jacket material to the pipe in one step, it is possible to use various combinations of method steps which differ essentially in terms of the preparation of the pipe immediately before it enters an extruder. The adhesion promoter is applied to the surface in the form of a thin film. The processing temperature is governed by the nature and composition of the adhesion promoter; the thermal resistance and also the melting point of the polymer matrix play a significant role here. The adhesion promoter is applied to the surface in the form of a film, this surface being wetted in an optimum fashion and therefore utilizing the maximum actual surface available for chemical reactions between the functional groups and the metal.

Advantageously, polymers whose matrix has been functionalized, for example, by maleic anhydride or ionomers may be used as the adhesion promoter. Further substances with an activating effect may also be added to the adhesion promoter in the form of constituent parts. Peroxides on an organic or else on an inorganic basis are especially suitable for this purpose.

Given a suitable combination of adhesion promoter and jacket material, the jacket material is applied at such a high temperature that it heats the adhesion promoter and triggers the disintegration of the peroxide. This then oxidizes the surface. The concentration of the peroxide can be used to control the extent of oxidation of the surface. The peroxide has to be metered in precisely in order to ensure a quantitative reaction. At the same time, the concentration must not be so high that the polymer matrix suffers oxidative damage. Therefore, it has proved to be advantageous to add to the adhesion promoter an amount of antioxidants equivalent to the amount of peroxide. The oxidative effect of the adhesion promoter on the surface where metal and polymer make contact can thereby be restricted and simultaneous oxidative damage to the polymer can largely be prevented.

In a preferred embodiment of the invention, the adhesion promoter may be applied in the form of a film. The adhesion promoter and the sheathing may each advantageously be applied by means of two temporally and locally independent processes. This decouples the individual process steps from one another.

When coating copper surfaces, it has been found that secure adhesion is already established at values above 40 mN/m. In a further preferred embodiment, the surface tension of the activated metal pipe surface may be from 45 to 75 mN/m, particularly preferably from 55 to 75 mN/m. The surface energy of metals and polymers can easily be measured by means of test inks according to DIN 53364.

1. A method for the production of a metallic line pipe with a firmly adhering plastic sheathing, characterized
in that an activated metal pipe surface is produced by means of a plasma treatment or by means of a gas-burner flame, wherein the exposure time of the surface is less than 3 seconds,
in that a plastic sheathing is applied to the activated metal pipe surface, and
in that, at the time when the sheathing is being applied, the temperature of the metal pipe surface is less than 80° C.

2. The method as claimed in claim 1, characterized in that methane, propane or butane with an excess of air is used as burner gas when using a gas-burner flame.

3. The method as claimed in claim 2, characterized in that the burner gas has a 20-30-fold excess of air.

4. The method as claimed in claim 1, characterized in that, at the time when the sheathing is being applied, the temperature of the metal pipe surface is from room temperature up to at most 50° C.

5. The method as claimed in claim 1, characterized in that the metal pipe surface is provided with an adhesion promoter before the sheathing is applied.

6. The method as claimed in claim 5, characterized in that polymers functionalized with maleic anhydride or ionomers are used as the adhesion promoter.

7. The method as claimed in claim 5, characterized in that the adhesion promoter is applied in the form of a film.

8. The method as claimed in claim 5, characterized in that the adhesion promoter and the sheathing are each applied by means of two temporally and locally independent processes.

9. The method as claimed in claim 1, characterized in that the surface tension of the activated metal pipe surface is from 45 to 75 mN/m.

10. The method as claimed in claim 9, characterized in that the surface tension of the activated metal pipe surface is from 55 to 75 mN/m.
